(19) United States
(12) Patent Application Publication
(10) Pub. No.: US 2006/0059121 A1
(43) Pub. Date: Mar. 16, 2006

(54) Method and system for identifying an author of a paper

(75) Inventors: Benyu Zhang, Beijing (CN); Hua-Jun Zeng, Beijing (CN); Wei-Ying Ma, Beijing (CN); Zheng Chen, Beijing (CN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 10/930,617

(22) Filed: Aug. 31, 2004

(51) Int. Cl. G06F 17/30; G06K 9/62

(52) U.S. Cl. 707/3; 707/5; 382/224

(57) ABSTRACT

A system that identifies a person associated with a document is provided. The system retrieves a name associated with a document and reduces the name to a canonical form. The system then compares the canonical form of the name to the canonical form of the names of known persons. If a match is not found, then the system indicates that the person whose name is associated with the document is a previously unknown person. If a match is found, then the system compares attributes of the document with attributes of documents associated with the matching known person. If those attributes are similar, then the system indicates that the person whose name is associated with the document is the matching known person. Otherwise, the system indicates that the person whose name is associated with the document is a previously unknown person.

### TECHNICAL FIELD

The described technology relates generally to searching for scientific papers and particularly to identifying the author of a paper.

### BACKGROUND

Many scientific papers are now being published electronically via the Internet. These papers can be published in various formats such as an HTML-based format, an XML-based format, a portable document format, a revisable text format, and so on. These papers in their various formats can be published at web sites of scientific societies (e.g., Association for Computing Machinery (“ACM”)), of universities, of individual authors, and so on. Some of these web sites provide search tools that can be used to locate and review papers of interest. For example, a person interested in the subject of complexity of computer algorithms may visit the ACM web site and enter the search phrase “complexity algorithms” to locate papers of interest. Papers of interest can also be located using search engine services that crawl the web to locate scientific papers. The search engine services index web pages for later retrieval via search tools.

Some web sites have been developed specifically to provide access through a single point to scientific papers that are published by various organizations. These web sites can locate papers by crawling the web, monitoring mailing lists, linking to publisher web sites, and so on. Such web sites may scan the papers to extract citation information. For example, a web site may automatically create a citation index by extracting citations, identifying citations to the same article that occur in different formats, and identifying the context of citations in the body (or text) of the papers. These web sites allow a user to search for papers based on keywords. Once a paper is located, the web sites may indicate the papers that are cited by the located paper and those papers that cite to the located paper. In addition, the web sites may identify related papers using, for example, a term frequency by inverse document frequency (“TD*IDF”) metric or a common citation by inverse document frequency (“CC*IDF”) metric to identify important information about the papers. Papers that have similar important information may be related.

When a paper is automatically located, it can be difficult to identify certain information about the paper, such as the name and identity of the author. Although some papers may include attribute fields that identify such information, most papers do not. Moreover, there is no standard format for storing such information within the text of the papers. For example, the authors of a paper may be listed in a last name followed by first initial format or a first name followed by last name format. In addition, a listing of the authors may include various elements such as titles or academic degrees (e.g., Sr. or M.D.), the names of their affiliated organizations, and so on. Moreover, because the names of the authors may be listed in one of many different locations within a paper (e.g., immediately after the title or within footnotes), it can be difficult to even locate the names within the text of the paper. Even if the name of an author can be identified, it can be difficult to determine the true identity of the author. For example, a paper listing “J. Smith” as an author may be referring to John Smith or Joe Smith. The true identity of the author can be useful, for example, in identifying related papers because papers by the same “J. Smith” may be more related than those by another “J. Smith.” It would be desirable to have a technique that would assist in identifying the names of the authors of papers and their true identities.

### SUMMARY

A system that identifies a person associated with a document is provided. The system retrieves a name associated with a document (e.g., the name of an author of the document) and reduces the name to a canonical form. The system then compares the canonical form of the name to the canonical form of the names of known persons. If a match is not found, then the system indicates that the person whose name is associated with the document is a previously unknown person. If a match is found, then the system compares attributes of the document with attributes of documents associated with the matching known person (e.g., co-authors or topics of documents authored by that known person). If those attributes are similar, then the system indicates that the person whose name is associated with the document is the matching known person. Otherwise, the system indicates that the person whose name is associated with the document is a previously unknown person.

### BRIEF DESCRIPTION OF THE DRAWINGS

FIG. 1 is a display page that illustrates the entry of a search query for scientific papers in one embodiment.

FIG. 2 is a display page that illustrates the display of a search result in one embodiment.

FIG. 3 is a display page that illustrates the display of additional information of the search result in one embodiment.

FIG. 4 is a display page that illustrates the display of further additional information of the search result in one embodiment.

FIG. 5 is a display page that illustrates the display of the topic directory in one embodiment.

FIG. 6 is a display page that illustrates information that is displayed when a topic is selected in one embodiment.

FIG. 7 is a display page that illustrates information that is displayed when a paper is selected in one embodiment.

FIG. 8 is a block diagram illustrating components of the retrieval system in one embodiment.

FIG. 9 is a flow diagram that illustrates the processing of the index papers component in one embodiment.

FIG. 10 is a flow diagram that illustrates the processing of the extract metadata component in one embodiment.

FIG. 11 is a flow diagram illustrating the processing of the extract author name component in one embodiment.

FIG. 12 is a flow diagram that illustrates the processing of a component that determines whether a sequence of words is a valid name string.

FIG. 13 is a flow diagram that illustrates the processing of a component to determine whether a name corresponds to an electronic mail address in one embodiment.

FIG. 14 is a flow diagram that illustrates the processing of the identify author component in one embodiment.

FIG. 15 is a flow diagram that illustrates the processing of the train classifier component in one embodiment.

FIG. 16 is a flow diagram that illustrates the processing of the classify papers component in one embodiment.

### DETAILED DESCRIPTION

A method and system for searching for and retrieving documents is provided. In one embodiment, the document retrieval system locates documents that are accessible via a communications network, such as the Internet. The retrieval system then extracts metadata from the text of the located documents. The metadata may include the title, authors, abstract, keywords, citations, citation list, and so on of the documents. The retrieval system then indexes the documents based on the extracted metadata for ease of retrieval. For example, the documents may be indexed by author and words of the title. The retrieval system provides a search engine through which a user can enter a search query when searching for documents. The retrieval system may use the index to identify documents that match the search query, that is, the search result. The retrieval system then displays information relating to the documents of the search result. A user can interact with the retrieval system to view additional information relating to the search result as described below in detail.

In one embodiment, the retrieval system identifies an author of a document by comparing a canonical form of the author's name retrieved from the document to the canonical form of the names of known authors. For example, the canonical form of “John Smith” may be “J. Smith.” The retrieval system retrieves the author's name from the document and then reduces that name to the canonical form. The retrieval system compares the canonical form of the author's name to the canonical form of the names of the known authors. The retrieval system may maintain a mapping of the canonical form of the name of each known author to information about that author (e.g., full name, authored documents, and employer). If there is no match between the canonical form of the author's name and the canonical form of the name of a known author, then the retrieval system indicates that the author of the document is a previously unknown author. If, however, there is a match between the canonical form of the author's name and the canonical form of the name of a known author, then the retrieval system determines whether those names represent the same author. In one embodiment, the retrieval system makes this determination based on a comparison of co-authors associated with those names. The retrieval system identifies the co-authors of the document and the co-authors associated with the known author. If there is overlap between the co-authors, then the retrieval system may assume that the document author is the same person as the known author. For example, if the document has a co-author of “T. Jones” and the known author has co-authored several documents with “T. Jones,” then the retrieval system assumes the document author and the known author are the same. Alternatively, the retrieval system may make this determination based on the topic (or subject) of the document and the topic of documents authored by the known author. For example, if the document is computer science related, and the known author has authored documents in the chemical area, then the retrieval system may assume that the document author and the known author are not the same person. The retrieval system may also look at other attributes of the document author and the known author, such as affiliated organization (e.g., university) and contact information (e.g., electronic mail address). If the retrieval system determines that the document author and the known author are probably not the same person, then the retrieval system may store both authors' names using an expanded form (e.g., “John Smith”), rather than a canonical form (e.g., “J. Smith”) to help in distinguishing the authors.

In one embodiment, the retrieval system may use an electronic mail address of a document to assist in determining whether a potential author name (i.e., words or initials that appear to be a name) is the name of the document author. The retrieval system may scan the document trying to identify the potential author names. When the retrieval system identifies words that may be an author name (e.g., words below the title), the retrieval system compares that potential author name to electronic mail addresses of the document to determine whether portions of the address are derivable from the name. For example, the retrieval system may identify the words “John D. Smith” as being a potential author name. The retrieval system may also determine that the document contains the electronic mail address of “jdsmith@acme.com.” In such a case, the retrieval system may determine that the author's last name (i.e., “Smith”) is contained within the prefix “jdsmith” of the electronic mail address. The retrieval system considers this containment as an indication that the electronic mail address is derivable from the potential author name and can be used in determining whether the potential author name is really the name of a document author. One skilled in the art will appreciate that the technique of comparing a potential name to an electronic mail address to determine whether the potential name is the name of a person can be used in contexts unrelated to the document authorship. For example, the technique can be used to determine whether a potential name within the body of an electronic mail message is a name and further is a name of a recipient.

In another embodiment, the document retrieval system automatically classifies documents according to their primary topic (or domain), such as computer science, chemistry, physics, and so on. The document retrieval system may further classify documents according to a hierarchy of topics. For example, the primary topic of computer science may have sub-topics of data structures, operating systems, compilers, and so on. The sub-topic of data structures may have further sub-topics of trees, hash tables, linked lists, and so on. The retrieval system initially trains a classifier using a collection of documents with known topics. The classifier may comprise a sub-classifier for each topic within the hierarchy. For example, there may be a sub-classifier for each of the computer science topic, the data structures sub-topic, and the trees sub-sub-topic. The retrieval system trains the computer science sub-classifier using all documents in the collection along with an indication of whether the document is classified as computer science or not. The retrieval system trains the data structures sub-classifier using the computer science documents along with an indication of whether the document is classified as data structures or not. The retrieval system may train the sub-classifiers using a topic feature vector that represents the topic of a document. For example, the topic feature vector may be the 10 most important words (e.g., keywords) of the document.

After training the classifier, the retrieval system can then classify newly located documents. To classify a document, the retrieval system generates a topic feature vector for the document. The retrieval system then invokes each sub-classifier for the highest level topics using the topic feature vector. The retrieval system then selects the best matching highest level topic as indicated by the sub-classifiers as the topic of the document. The retrieval system may then invoke each sub-classifier for the sub-topics of the topic of the document to determine the sub-topic of the document. The retrieval system may continue this process for each level of the topic hierarchy. In addition, the retrieval system may identify multiple primary topics or secondary topics of a document. For example, the classifier may indicate that a document is very highly related to computer science and chemistry, in which case the document may have two primary topics. The classifier may also indicate that a document is highly related to computer science and less related to chemistry, in which case the document may have a primary topic and a secondary topic.

In one embodiment, the retrieval system uses a support vector machine classifier to classify documents according to topic. A support vector machine operates by finding a hyper-surface in the space of possible inputs based on the training data. The hyper-surface attempts to split the positive examples (e.g., topic feature vector and topic pairs) from the negative examples (e.g., topic feature vector and not topic pairs) by maximizing the distance between the nearest of the positive and negative examples to the hyper-surface. This allows for correct classification of data that is similar to but not identical to the training data. Various techniques can be used to train a support vector machine. One technique uses a sequential minimal optimization algorithm that breaks the large quadratic programming problem down into a series of small quadratic programming problems that can be solved analytically. (See Sequential Minimal Optimization, at http://research.microsoft.com/˜jplatt/smo.html.) Alternatively, the retrieval system may use linear regression, logistics regression, and other regression techniques to classify documents.

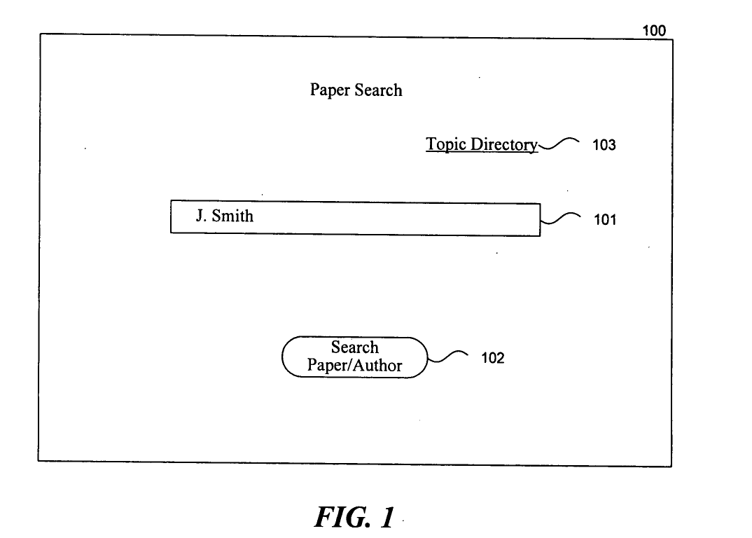

FIG. 1 is a display page that illustrates the entry of a search query for scientific papers in one embodiment. The display page 100 includes a text box 101, a search button 102, and a topic directory link 103. A user enters the search query in the text box. The search query may be the name of the author or a portion of the title of a paper. The user selects the search button to request the retrieval system to search for related papers. The retrieval system may first attempt to identify whether the search query represents the name of an author or the title of a paper. The retrieval system may make this determination based on whether the words of the search query correspond to names of known authors. Alternatively, the retrieval system may allow a user to submit a search query that represents keywords within the text of the papers. When selected, the topic directory link displays a listing of the topic hierarchy of the retrieval system.

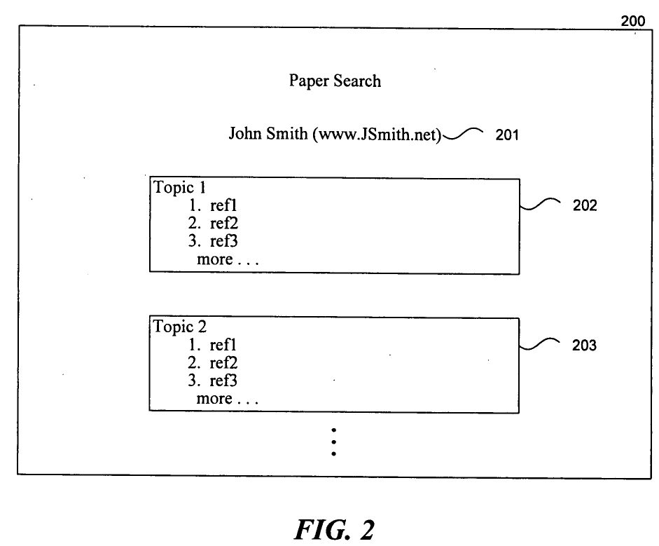

FIG. 2 is a display page that illustrates the display of a search result in one embodiment. The display page 200 includes an identity of the author 201 and links to various papers written by that author organized into topics 202-203. The identity of the author includes the name of the author along with the electronic mail address, web page address, and so on associated with the author. Each paper listed under the topics 202-203 may be a link to a web page for displaying further information related to the paper.

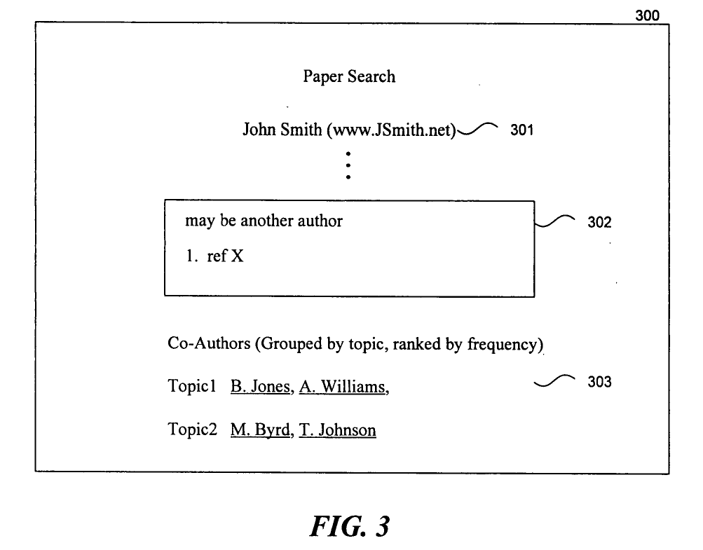

FIG. 3 is a display page that illustrates the display of additional information of the search result in one embodiment. The display page 300 includes an identity of the author 301, possible papers of the author 302, and a list of co-authors 303. If the retrieval system is not confident that it correctly determined the identity of an author of a paper, but it appears that the author may be the identified author, then the retrieval system may list that paper as potentially being authored by the identified author. In one embodiment, the retrieval system lists the co-authors of the identified author by topic ranked by frequency of co-authorship within topic. For example, “B. Jones” may have been a co-author on five papers with “John Smith” related to topic 1 and “A. Williams” may have been a co-author on three papers with “John Smith” related to topic 1. If so, then “B. Jones” is listed before “A. Williams.”

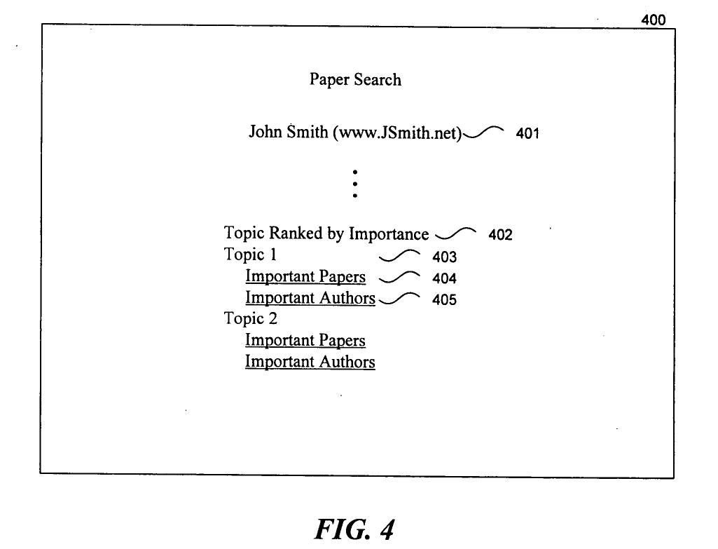

FIG. 4 is a display page that illustrates the display of further additional information of the search result in one embodiment. The display page 400 includes an identity of the author 401 and a listing 402 of topics of the papers authored by the identified author ranked by importance of the topics to the identified author. The importance of a topic to an author may be based on the number of papers authored by the author within a topic, the importance of the papers to the topic generally, and so on. Each topic 403 may contain links to important papers 404 and important authors 405 within that topic. In one embodiment, the retrieval system may identify important papers within a topic by applying a page rank type analysis to the citations of papers. Such a ranking is described in U.S. application Ser. No. 10/846,835 entitled “Method and System for Ranking Objects Based on Intra-type and Inter-type Relationships” and filed on May 14, 2004, which is hereby incorporated by reference. The retrieval system may identify the important authors in a similar manner.

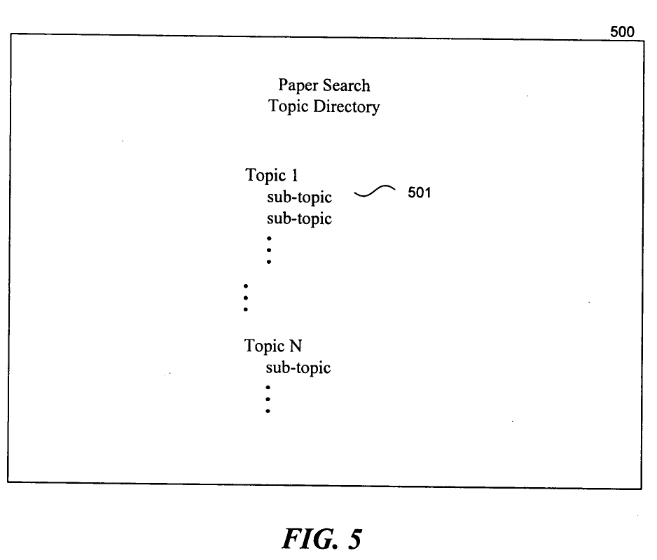

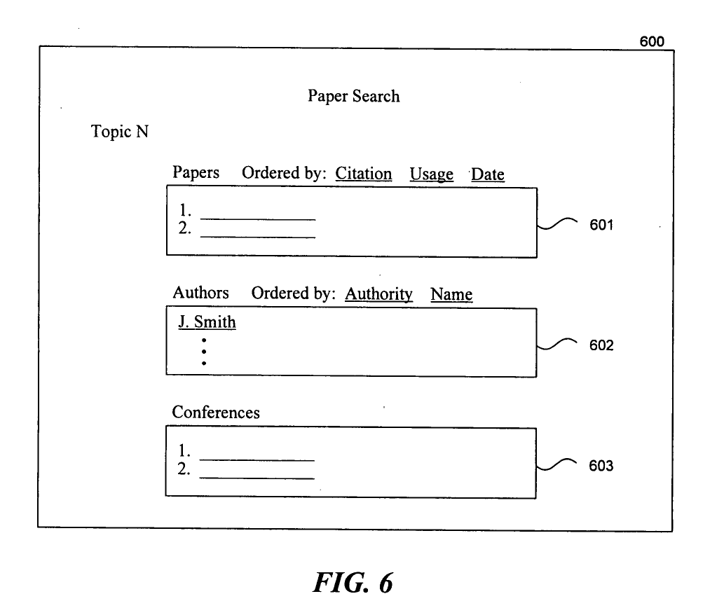

FIG. 5 is a display page that illustrates the display of the topic directory in one embodiment. The display page 500 includes a topic directory 501. The topic directory includes links to each topic and each sub-topic within a topic. FIG. 6 is a display page that illustrates information that is displayed when a topic is selected in one embodiment. The display page 600 includes a papers area 601, an authors area 602, and a conferences area 603. The papers area includes links to papers relating to that topic. The papers can be sorted by citation, usage (e.g., importance), and date. The authors area includes the names of the authors of papers within the selected topic and may be ordered by authority (i.e., importance of author to that topic) or alphabetically. The conferences section includes a list of various conferences related to the selected topic.

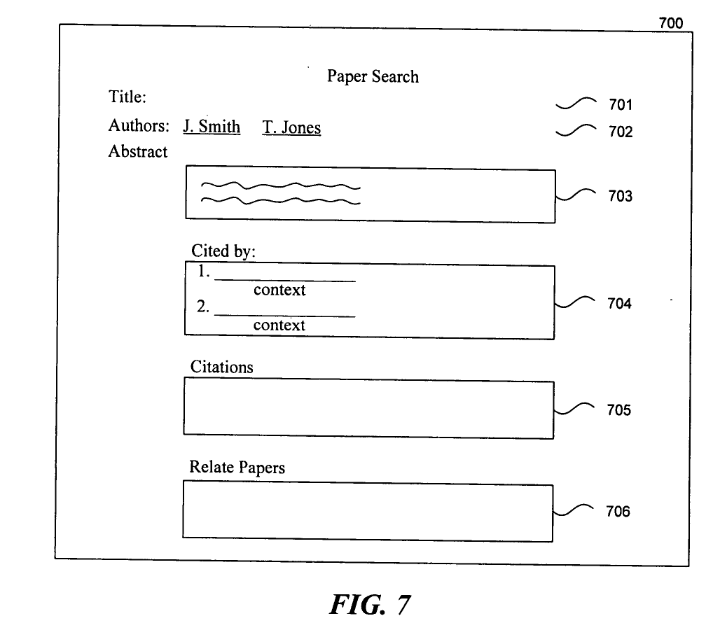

FIG. 7 is a display page that illustrates information that is displayed when a paper is selected in one embodiment. The display page 700 includes a title area 701, an authors area 702, an abstract area 703, a cited-by area 704, a citations area 705, and a related papers area 706. The authors area may include links to web pages or additional information related to the authors. The cited-by area identifies the papers that cite the selected paper and may include the context of the citation. For example, the context may include the sentence before and after the citation, a certain number of words before and after the citation, and so on. The related papers area may list papers that are similar to the selected paper, which may be determined by the similarity of the keywords of the papers.

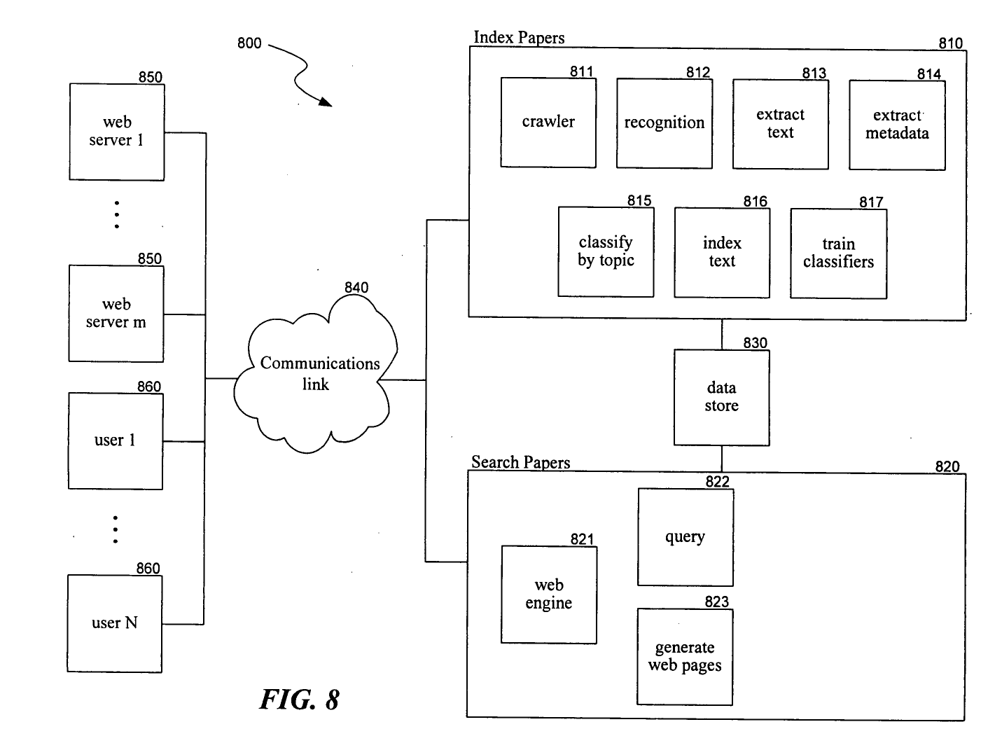

FIG. 8 is a block diagram illustrating components of the retrieval system in one embodiment. The retrieval system 800 includes an index papers component 810, a search papers component 820, and a data store 830. The index papers component and the search papers component are connected to web servers 850 and user computers 860 via a communications link 840. The index papers component includes a crawler component 811, a recognition component 812, an extract text component 813, an extract metadata component 814, a classify by topic component 815, an index text component 816, and a train topic classifier component 817. The crawler component crawls the web pages of the web servers to identify papers that are to be indexed. The recognition component may perform text recognition as appropriate to capture the text of the papers. The extract text component retrieves the text of the papers. The extract metadata component retrieves various metadata associated with the papers. The metadata may include title, author name, citation list, citations, and so on. The classify by topic component classifies the papers by their primary topic. The index text component generates an index of the text of the papers and stores the index and the papers in the data store. The train topic classifier component trains a classifier to classify the papers by their primary topic. The search papers component includes a web engine 821, a query component 822, and a generate web page component 823. The web engine receives requests for web pages, invokes the query component to retrieve results associated with requests, and invokes the generate web page component to formulate web pages for displaying the results of requests.

The computing device on which the retrieval system is implemented may include a central processing unit, memory, input devices (e.g., keyboard and pointing devices), output devices (e.g., display devices), and storage devices (e.g., disk drives). The memory and storage devices are computer-readable media that may contain instructions that implement the retrieval system. In addition, the data structures and message structures may be stored or transmitted via a data transmission medium, such as a signal on a communications link. Various communications links may be used, such as the Internet, a local area network, a wide area network, or a point-to-point dial-up connection.

The retrieval system may be implemented in various operating environments that include personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The retrieval system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

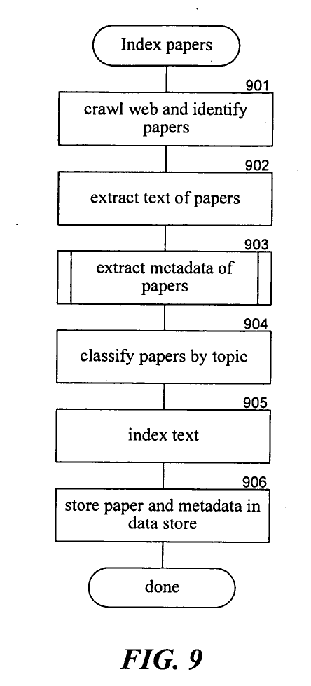

FIG. 9 is a flow diagram that illustrates the processing of the index papers component in one embodiment. In block 901, the component crawls the web to identify papers to be indexed. In block 902, the component extracts the text of the papers. In block 903, the component extracts the metadata of the papers. In block 904, the component classifies the papers by their primary topic. In block 905, the component indexes the text of the papers. In block 906, the component stores the papers and metadata in the data store and then completes.

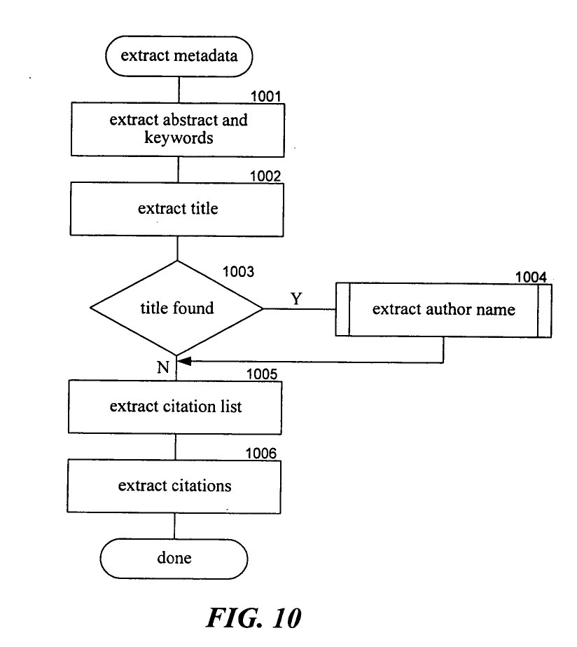

FIG. 10 is a flow diagram that illustrates the processing of the extract metadata component in one embodiment. The component is passed a paper and extracts the metadata from the paper. In block 1001, the component extracts the abstract and keywords from the paper. The component may identify an abstract as a paragraph following the word “abstract,” as the initial paragraph of the paper when it is formatted differently than other paragraphs of the paper, as an initial paragraph that ends in keywords, and so on. In block 1002, the component extracts the title from the paper. In decision block 1003, if the title is found, then the component continues at block 1004, else the component continues at block 1005. In block 1004, the component extracts the author names from the paper. The author names may be extracted on the assumption that they are listed after the title. In block 1005, the component extracts the citation list from the paper. The reference or citation list may be located at the end of the paper as a series of numbered or lettered end notes. In block 1006, the component extracts the citations in the text along with the context of the citations. The component then completes.

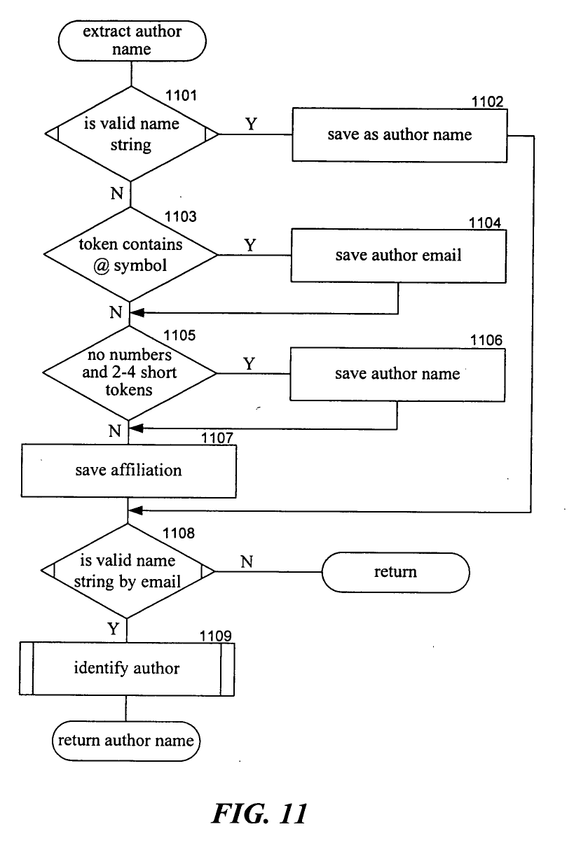

FIG. 11 is a flow diagram illustrating the processing of the extract author name component in one embodiment. The component is passed a sequence of words that may be an author name. In decision block 1101, if the passed author name is a valid name string (e.g., not too many words), then the component continues at block 1102, else the component continues at block 1103. In block 1102, the component saves the sequence of words as the author name and continues at block 1108. In decision block 1103, if the passed author name contains an “@” symbol, then the component continues at block 1104 to save the sequence as an electronic mail address and then continues at block 1105. In decision block 1105, if the passed author's name contains no numbers and number of short words (e.g., initials) within the passed author name is two, three, or four, then the component continues at block 1106, else the component continues at block 1107. In block 1106, the component saves the sequence of words as the author name and continues at block 1107. In block 1107, the component saves any affiliation associated with the author name (e.g., ACM). In decision block 1108, if an electronic mail address is derivable from the author name, then the component continues at block 1109, else the component returns an indication that the passed sequence of words is not an author name. In block 1109, the component determines the true identity of the author and returns the author name.

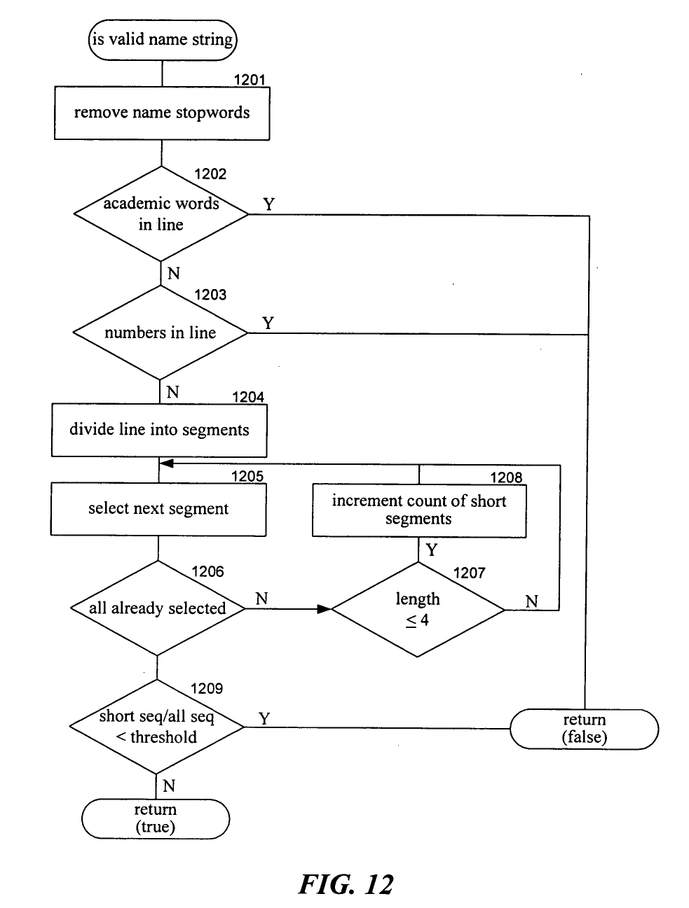

FIG. 12 is a flow diagram that illustrates the processing of a component that determines whether a sequence of words is a valid name string. In block 1201, the component removes stop words from the sequence. In decision block 1202, if there are academic words (e.g., university) in the sequence, then the component returns an indication of false, else the component continues at block 1203. In decision block 1203, if there are numbers in the sequence, then the component returns an indication of false, else the component continues at block 1204. In block 1204, the component identifies segments of the sequence as words and initials of the sequence. In blocks 1205-1208, the component loops selecting each segment and determining whether the segment is short. In block 1205, the component selects the next segment. In decision block 1206, if all the segments have already been selected, then the component continues at block 1209, else the component continues at block 1207. In decision block 1207, if the length of the selected segment is less than four, then the segment is a short segment and the component continues at block 1208, else the component loops to block 1205 to select the next segment. In block 1208, the component increments a count of short segments and loops to block 1205. In decision block 1209, if the number of the short segments divided by the total number of segments is less than a threshold, then the component returns an indication that the name is not a valid name, else the component returns an indication that the name is a valid name.

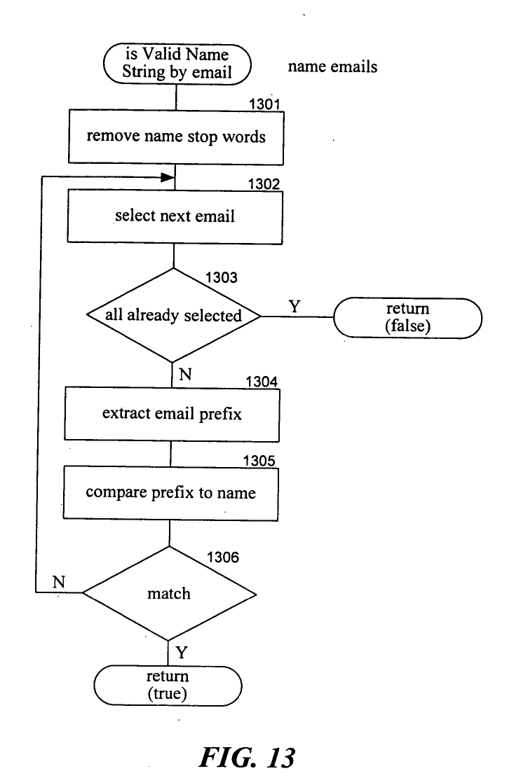

FIG. 13 is a flow diagram that illustrates the processing of a component to determine whether a name corresponds to an electronic mail address in one embodiment. The component is passed a name and a list of electronic mail addresses. In block 1301, the component removes stop words from the name. In blocks 1302-1306, the component loops determining whether the name can be used to derive an electronic mail address. In block 1302, the component selects the next electronic mail address. In decision block 1303, if all the electronic mail addresses have already been selected, then no address is derivable and the component returns an indication that the name is not a valid name, else the component continues at block 1304. In block 1304, the component extracts the prefix of the selected electronic mail address. In block 1305, the component compares the prefix to the name. In decision block 1306, if the prefix is derivable from the name, then the component returns an indication that the name is a valid name, else the component loops to block 1302 to select the next electronic mail address.

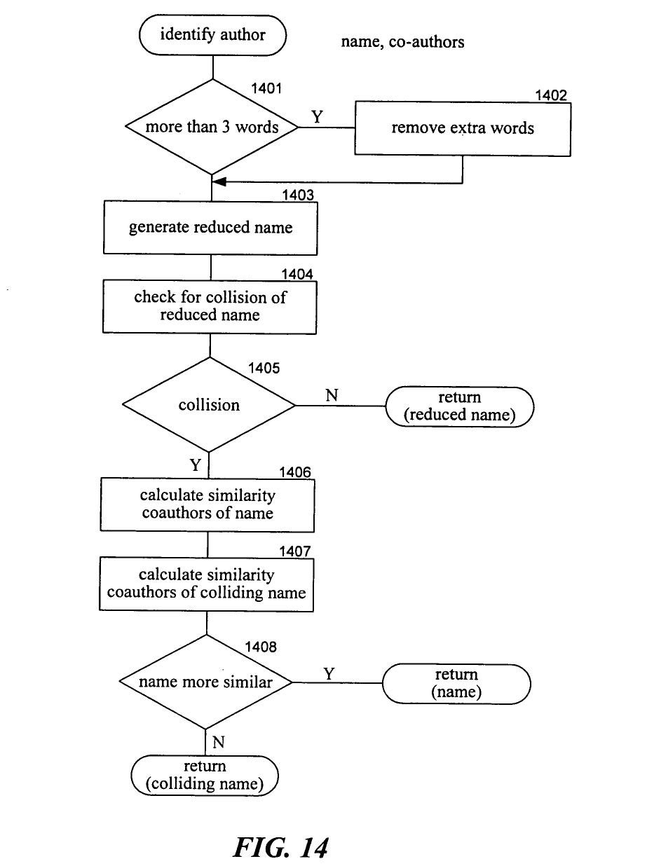

FIG. 14 is a flow diagram that illustrates the processing of the identify author component in one embodiment. The component is passed the name of an author of a paper along with the co-authors of that paper. In decision block 1401, if the name has more than three words or segments, then the component continues at block 1402, else the component continues at block 1403. In block 1402, the component removes any extra words from the name. For example, if the name is “Thomas J. B. Smith,” the component may remove the “B.” In block 1403, the component reduces the name to its canonical form. For example, the canonical form of “Thomas J. Smith” may be “T. Smith.” In block 1404, the component checks whether the canonical form of the name matches the canonical form of the name of a known author. In decision block 1405, if it matches, then the component continues at block 1406, else the component returns an indication that the author is a previously unknown author. In block 1406, the component evaluates the similarity between the co-authors of the paper with the co-authors of the author with the matching name. In decision block 1407, if there is a significant overlap between the co-authors, then the component assumes that the author of the paper and the matching author are the same and returns an indication that the author of the paper is a known author, else the component returns an indication that the author of the paper is a previously unknown author.

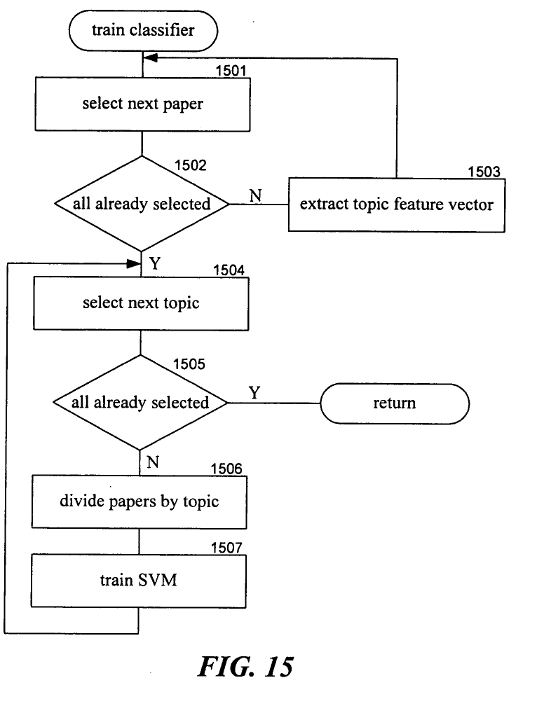

FIG. 15 is a flow diagram that illustrates the processing of the train classifier component in one embodiment. In one embodiment, the classifier may be a support vector machine classifier that includes a sub-classifier for each topic and each sub-topic of the topic directory. In this example, the component trains the sub-classifiers for the highest level topics. In blocks 1501-1503, the component loops selecting papers and extracting the topic feature vector from the selected paper. In block 1501, the component selects the next paper. In decision block 1502, if all the papers have already been selected, then the component continues at block 1504, else the component continues at block 1503. In block 1503, the component extracts the topic feature vector from the selected paper and loops to block 1501 to select the next paper. In blocks 1504-1507, the component loops training the sub-classifier for each topic. In block 1504, the component selects the next topic. In decision block 1505, if all the highest level topics have already been selected, then the component completes, else the component continues at block 1506. In block 1506, the component designates the paper as being related to the selected topic or not. In block 1507, the component trains the support vector machine classifier for the selected topic using the topic feature vectors for the papers. The component then loops to block 1504 to select the next primary topic.

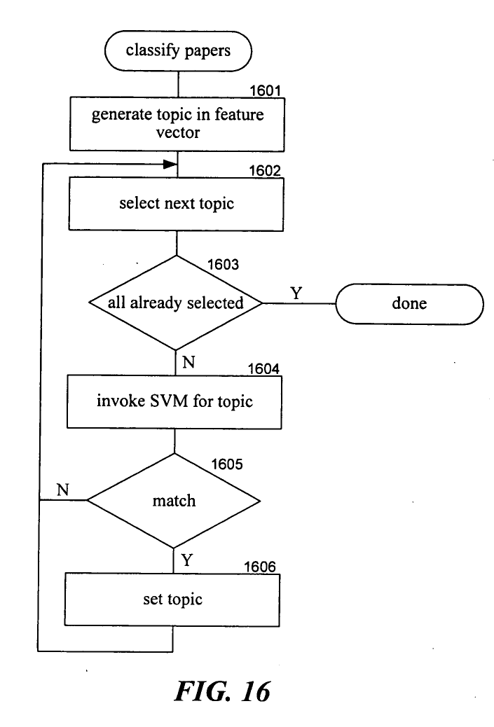

FIG. 16 is a flow diagram that illustrates the processing of the classify papers component in one embodiment. The component is passed a paper that is to be classified and classifies it within the highest level topics. In block 1601, the component generates the topic feature vector for the paper. In blocks 1602-1606, the component loops selecting each highest level topic and determining whether the paper can be classified within that topic. In block 1602, the component selects the next topic. In decision block 1603, if all the highest level topics have already been selected, then the component completes, else the component continues at block 1604. In block 1604, the component invokes the support vector machine for the selected topic. In decision block 1605, if the support vector machine indicates a match, then the component continues at block 1606, else the component loops to block 1602 to select the next topic. In block 1606, the component sets the topic for the paper and then loops to block 1602 to select the next topic. In one embodiment, the component may identify multiple topics associated with the paper. In such a case, the topics may be ranked according to their support as indicated by a distance metric of the support vector machine.

One skilled in the art will appreciate that although specific embodiments of the retrieval system have been described herein for purposes of illustration, various modifications may be made without deviating from the spirit and scope of the invention. For example, the retrieval system can be used to index and retrieve documents in any subject area and is not limited to scientific papers. The term “document” refers to any collection of words such as papers, articles, stories, and so on. In one embodiment, the canonical form of an author name may be generated by applying a hash function or some other function to the author name. Accordingly, the invention is not limited except by the appended claims.

I/We claim

1. A method in a computer system for identifying an author of a document, the method comprising:
providing a canonical form of the names of known authors;
retrieving an author name from the document;
reducing the author name to a canonical form;
when the canonical form of the author name does not match the canonical form of the name of a known author, indicating that the author of the document is a previously unknown author; and
when the canonical form of the author name does match the canonical form of the name of a known author,
identifying co-authors of the document;
identifying co-authors of the matching known author;
when the identified co-authors of the document and of the matching known author are similar, indicating that the author of the document is the matching known author; and
when the identified co-authors of the document and of the matching known author are not similar, indicating that the author of the document is a previously unknown author.

2. The method of claim 1 including when the identified co-authors of the document and of the matching known author are not similar, expanding the canonical form of the author name.

3. The method of claim 3 including when the identified co-authors of the document and of the matching known author are not similar, expanding the canonical form of the name of the known author.

4. The method of claim 1 wherein the canonical form of an author name includes an initial of a first name of the author and a last name of the author.

5. The method of claim 4 wherein the canonical form of an author name includes an initial of a middle name of the author.

6. The method of claim 1 wherein the retrieving of an author name of the document includes identifying an electronic mail address of the document and determining whether a potential author name matches the electronic mail address.

7. The method of claim 6 wherein a potential author name matches the electronic mail address when a prefix of the electronic mail address is derivable from the potential author name.

8. A computer-readable medium containing instructions for controlling a computer system to identify a person associated with a document, by a method comprising:
providing names of known persons along with attributes of documents associated with the known persons;
retrieving a name associated with the document;
when the name does not match the name of a known person, indicating that the name associated with the document is of a previously unknown person; and
when the name does match the name of a known person,
identifying attributes of the document;
identifying attributes of documents associated with the matching known person; and
when the identified attributes of the document and of the documents associated with the matching known person are similar, indicating that the person associated with the document is the matching known person.

9. The computer-readable medium of claim 8 including when the identified attributes are not similar, indicating that the person associated with the document is a previously unknown person.

10. The computer-readable medium of claim 9 wherein the names match when a canonical form of each name is the same.

11. The computer-readable medium of claim 10 including when the identified attributes are not similar, expanding the canonical form of the name.

12. The computer-readable medium of claim 11 including when the identified attributes are not similar, expanding the canonical form of the name of the known person.

13. The computer-readable medium of claim 8 wherein the association is authorship of the document.

14. The computer-readable medium of claim 13 wherein the attributes are co-authors.

15. The computer-readable medium of claim 8 wherein the retrieving of a name includes identifying an electronic mail address of the document and determining whether a potential name matches the electronic mail address.

16. The computer-readable medium of claim 15 wherein a potential name matches the electronic mail address when a prefix of the electronic mail address is derivable from the potential name.

17. A method in a computer system for identifying a name of an author of a document, the method comprising:
identifying an electronic mail address associated with the document;
identifying a potential name associated with the document;
determining whether the potential name matches the electronic mail address; and
when the potential name matches the electronic mail address, indicating that the potential name is a name associated with the document.

18. The method of claim 17 wherein the potential name matches the electronic mail address when a prefix of the electronic mail address is derivable from the potential name.

19. The method of claim 18 wherein the prefix of the electronic mail address is derivable from the potential name when the prefix includes a last name of the potential name.

20. The method of claim 18 wherein the prefix of the electronic mail address is derivable from the potential name when the prefix includes a first name of the potential name.

21. A computer-readable medium containing instructions for controlling a computer system to identify a name of a person associated with a document, by a method comprising:
determining whether a potential name of a person matches an electronic mail address associated with the document; and
when the potential name of the person matches the electronic mail address, indicating that the potential name is a name of a person.

22. The computer-readable medium of claim 21 wherein the potential name is the name of an author of the document.

23. The computer-readable medium of claim 21 wherein the potential name of the person matches the electronic mail address when a prefix of the electronic mail address is derivable from the potential name.

24. The computer-readable medium of claim 23 wherein the prefix of the electronic mail address is derivable from the potential name when the prefix includes a last name of the potential name.

25. The computer-readable medium of claim 23 wherein the prefix of the electronic mail address is derivable from the potential name when the prefix includes a first name of the potential name.

26. A method in a computer system for classifying documents by topic, the method comprising:
providing documents along with an indication of the topic of each document;
generating topic feature vectors for the documents;
training a classifier with the topic feature vectors and the topics to classify documents according to topics;
receiving a document to be classified by topic;
generating a topic feature vector for the document; and
invoking the classifier with the generated topic feature vector to classify the document according to topic.

27. The method of claim 26 wherein a topic feature vector is derived from keywords of a document.

28. The method of claim 27 wherein the keywords are derived from an abstract of the document.

29. The method of claim 27 wherein the keywords are important words of the document.

30. The method of claim 26 wherein the classifier includes a sub-classifier for each topic.

31. The method of claim 30 wherein each sub-classifier is a support vector machine based classifier.

32. A computer-readable medium containing instructions for controlling a computer system to generate a classifier to classify documents by subject, by a method comprising:
providing documents along with an indication of the subject of each document;
generating subject feature vectors for the documents; and
training a classifier with the subject feature vectors and the subjects to classify documents according to subjects.

33. The computer-readable medium of claim 32 including:
receiving a document to be classified by subject;
generating a subject feature vector for the document; and
invoking the classifier with the generated subject feature vector to classify the document according to subject.

34. The computer-readable medium of claim 32 wherein a subject feature vector is derived from keywords of a document.

35. The computer-readable medium of claim 32 wherein the classifier includes a sub-classifier for each subject.

36. The computer-readable medium of claim 35 wherein each sub-classifier is a support vector machine based classifier.

37. The computer-readable medium of claim 32 wherein each sub-classifier is trained using subject feature vectors for the subject of the sub-classifier.
